(19) United States
(12) Patent Application Publication
(10) Pub. No.: US 2026/0066750 A1
(43) Pub. Date: Mar. 5, 2026

(54) STRUCTURAL UNIT FOR AN ELECTRIC MACHINE AND METHOD AND TOOL SYSTEM FOR PRODUCING SUCH A STRUCTURAL UNIT

(71) Applicant: HOFFMANN GMBH, Pforzheim (DE)

(72) Inventors: Thomas BASLER, Straubenhardt (DE); Benjamin GRIESCH, Königsbach-Stein (DE); Patrik RIEDER, Stuttgart (DE); Daniel BACHSTÄDTER, Remchingen-Nöttingen (DE); Thomas HELM, Königsbach-Stein (DE)

(21) Appl. No.: 19/104,199

(22) PCT Filed: Aug. 15, 2023
(86) PCT No.: PCT/EP2023/072446

§ 371 Date: Mar. 4, 2025

(51) Int. Cl. H02K 15/0273; H02K 1/12

(52) U.S. Cl. CPC H02K 15/0273; H02K 1/12

(57) ABSTRACT

The invention relates to a structural unit and to a method and a tool system for producing such a structural unit for an electric machine, such as a rotor or in particular a stator, with a lamination stack (1) composed of a plurality of metal laminae layered on top of one another in the direction of a longitudinal axis, which lamination stack is, in the circumferential direction, assembled from multiple stack segments (10) with lamina segments which are arranged in the circumferential direction and interlock by means of lateral holding structures. High precision of the structural unit combined with flexible adjustment of the production process to meet different requirements is achieved in that the stack segments (10) forming the lamination stack (1) are constructed in layers in the same way from at least two different lamina segment groups A (2) of identically contoured A lamina segments (20) and lamina segment groups B (3) of identically contoured B lamina segments (30), wherein the A lamina segments (20) differ from the B lamina segments (30) in their holding structures in terms of their holding force in at least the radial direction in the plane of the metal laminae.

The invention relates to a structural unit for an electric machine, such as a rotor or in particular a stator, with a lamination stack, which is composed of a plurality of metal laminae layered on top of one another in the direction of a longitudinal axis and is assembled in the circumferential direction from multiple stack segments with lamina segments arranged in the circumferential direction and interlocking by means of lateral holding structures. Furthermore, the invention relates to a method and to a tool system for producing such a structural unit, in which a punching arrangement for cutting metal laminae to be layered on top of one another to form a lamination stack is present in a tool arrangement of a production system, wherein the punching arrangement has multiple cutting stations with cutting units for cutting the metal laminae into lamina segments which are assembled circumferentially by means of lateral holding structures so that they can be disassembled and reassembled after disassembly, and required further cutting portions of the metal laminae, and furthermore a stacking device controlled by a control apparatus is present for forming the lamination stack from stacked metal laminae, the lamination stack being composed of stack segments in the circumferential direction. The stack segments of the lamination stack can be pulled apart for further processing.

A structural unit, a method and a tool system of this type are disclosed in CA 2 758 405 C. In this known structural unit, a lamination stack for forming a ferromagnetic core, in particular a stator or rotor of an electric motor, is composed of circumferentially assembled stack segments, which are each formed from lamina segments stacked on top of one another in the direction of a longitudinal axis, wherein lamina segments with differently contoured holding structures are arranged within the stack segments. The stack segments assembled to form the lamination stack are held together by means of the holding structures, which are formed in the circumferential direction on the sides of the lamina segments in the cutting process and consist of convex protrusions on the one hand and concave recesses adapted to complement them on the other hand. Some of the holding structures are designed such that they are plastically deformed by means of a punch to exert a holding force, wherein other holding structures are designed to allow the punch to pass through. The stack segments, which are assembled in a circle with respect to the lamina plane to form the lamination stack, include stack segments having differently contoured holding structures. When producing the structural unit, various lamina segments with respective holding structures are cut in a tool system by means of a cutting apparatus and stacked in a stacking device to form stack segments, which are joined in a linear arrangement with their complementary holding structures, wherein some of the assembled holding structures are plastically deformed by means of the punch and, finally, the linear arrangement of the stack segments is assembled to form the ring-shaped lamination stack. The stack segments arranged at the ends of the lamination stack have a different structure with regard to the holding structures of the stacked lamina segments than the stack segments arranged between them.

EP 0 833 427 B1 also shows a structural unit, in particular also a stator core for a rotating electric machine, consisting of metal laminae, which are layered to form a lamination stack and are composed of lamina segments with lateral holding structures in a ring shape. Here, too, lamina segments are first cut and stacked in a tool system, and the stack segments formed in this manner are assembled. In one exemplary embodiment, lamina segments provided with different holding structures can also be present within the stack segments. With such a design, it is difficult to reliably ensure high precision of the structural unit.

DE 10 2017 201 178 A1 presents a structural unit for an electric machine and a method for producing it, in which individual lamina segments are assembled by means of lateral holding structures to form a ring-shaped metal lamina and the metal laminae are stacked to form a lamination stack. As a still unwound stator arrangement, the lamination stack formed in this manner is subsequently separated into its individual stack segments. The holding structures arranged laterally in the circumferential direction also consist of a tongue-and-groove connection and the length of the protrusion and, if necessary, a bracing perpendicular to the surface plane of the individual laminae are selected such that, after the individual lamina segments have been punched, they can be brought back into the ring-shaped form of the metal laminae so that the individual lamina segments are held together by stacking when the lamination stack or stator arrangement is constructed. This means that the stator arrangement formed in this manner and provided with tooth tips can be transported to a winding tool. The unwound stator arrangement can be separated into its individual stack segments, in particular by exerting a radial force, to wind them and subsequently to reassemble the individual stack segments to form the lamination stack or stator arrangement by applying a radial force directed toward each other with the aid of a joining tool. The metal laminae, which are completely cut all around, contribute to the high precision of the structural unit, but the joining and separating processes can have a detrimental effect on the joining forces.

EP 2 356 734 B2 shows an electric motor with a structural unit of a stator, which also has a lamination stack assembled from multiple stack segments with lateral holding structures.

EP 0 871 282 A1 shows lamination stacks made of metal laminae formed from integrally connected lamina segments.

CN 104874756 B, CN 107008962 A, and CN 108262519 B show cutting methods and cutting apparatuses for laminae.

As the above-mentioned publications also show, numerous topologies, geometries, and manufacturing methods for electric machines are known. Depending on the field of application, the requirements for torques, power, noise development, torque fluctuations, cogging torques, and material use vary greatly. Noise development, weight, and efficiency of the drive are regarded as the most important performance indicators. Influencing variables are roundness of the stator, current intensity, resistance, impedance of the system, copper fill factor, number of poles, air gap between stator and rotor, length of the active parts (stator, rotor), iron factor, and lamina thickness. The maximization of electrical conductivity through a high copper fill factor (and thus a high power density) and the minimization of the air gap are of particular importance here (see also Fräger, C., Amrhein, W. Handbuch Elektrische Kleinantriebe [Handbook of Small Electric Drives], volume 2: Systemkomponenten, Auslegung [System Components, Design], 5th edition 2021 ; VDI, 2015, Drehende elektrische Maschinen [Rotating Electric Machines], part 2-1: Standardverfahren zur Bestimmung der Verluste und des Wirkungsgrades aus Prüfungen) [Standard Methods for Determining the Losses and the Efficiency from Tests].

The underlying winding technology also plays a major role here since it has a significant influence on the performance indicators. The plug winding generally offers the highest copper fill factor but is limited in terms of scaling, and the manufacturing apparatuses are comparatively expensive. Further techniques are coil winding and needle winding, which are realized in various forms (straight groove, slanted groove, individual teeth (either completely separated individual teeth or as so-called pre-cut, i.e., not completely separated but only partially cut stator teeth) and full cut).

In order to reduce the eddy currents in the iron core, it is produced from individual metal laminae. The individual metal laminae are held together by so-called interlocking clamps, i.e., embossments on the surface of the laminae. Techniques for connecting lamina planes are inter alia described in DE 10 2012 224 153 A1 and in Liu, L.-H. and Liu L.-C. (2017), Analysis of interlocking performances on non-oriented electrical steels, AIP Advances 8, 056605 (2018).

The principal advantage of the full-cut method is that the lamination stack or the stator formed from it forms a (practically) perfect circle, which in turn has a positive effect on the air gap and the torque ripple. However, the full cut has the major disadvantage that the stator teeth are difficult to access for the winding head and the important copper fill factor therefore does not reach the level of a plug winding or the winding of a segmented stator. The segmented stator therefore offers a good alternative. However, it is difficult to reassemble the individual stack segments formed by the stacked, segmented metal laminae, or the individual stator teeth formed by them, into as round a circle as possible after the winding has been completed, in order to achieve a small air gap and low torque ripple. If the complete segmentation is carried out without maintaining the punching sequence of the stator teeth, it is almost impossible to produce a perfectly round circle. Furthermore, an additional welding process is usually required to reconnect the individual stator teeth. In the case of the so-called pre-cut technology, the teeth are pre-punched and then separated later in the process while maintaining the sequence and reassembled in the appropriate sequence after winding has been completed (in practice, pre-cut technology is also used without maintaining the sequence at the expense of poorer torque ripple and possibly with a larger air gap). It is also possible to completely punch through the lamina segments or stator teeth and to later assemble the stator teeth while maintaining the sequence, Positive and non-positive connections are available for this purpose, as the above-mentioned publications show. However, it is difficult to reliably maintain the form and force fit, in particular in the case of different laminated metal stacks, especially laminated metal stacks of different heights.

The present invention is based on the object of providing a structural unit for an electric machine as well as a method and a tool system for producing such a structural unit, with which the cohesion of stack segments in a lamination stack can be maintained as precisely and reliably as possible.

This object is achieved in a structural unit with the features of claim 1, in a method for producing it with the features of claim 5, and in a tool system with the features of claim 11.

According to the invention, it is provided in the structural unit that the stack segments forming the lamination stack are identically constructed in layers from at least two different lamina segment groups A of identically contoured A lamina segments and lamina segment groups B of identically contoured B lamina segments, wherein the A lamina segments differ from the B lamina segments in their holding structures in terms of their holding force in at least the radial direction in the plane of the metal laminae. In particular, it can be provided that the holding force of the B lamina segments is practically zero. With these measures, a holding force or pull-off and joining force can be reliably specified and controlled in the lamination stack or the stator formed from it.

In the method, it is provided that a metal band is fed to a tool arrangement and that A metal laminae with circumferentially joined A lamina segments as well as B metal laminae with circumferentially joined B lamina segments are cut out of the metal band, wherein lateral holding structures of the A lamina segments differ from lateral holding structures of the B lamina segments in their holding force, and A metal laminae and B metal laminae are automatically layered on top of one another in the direction of a longitudinal axis to form a lamination stack in a sequence specified by a control apparatus, so that the radial holding force between the stack segments layered from the A lamina segments and B lamina segments is within a specified holding force range.

In the structure of the tool system according to the invention, it is provided that two different cutting stations are present for cutting the lamina segments, one of which is designed for cutting A lamina segments, the lateral interlocking holding structures of which are designed to exert radial holding forces, and the other cutting station is designed for cutting B lamina segments, the lateral interlocking holding structures of which are designed to exert lower holding forces than the holding structures of the A lamina segments down to practically no holding forces, and that the stacking device is designed for arranging a number of A metal laminae, composed of A lamina segments, and a number of B metal laminae, composed of B lamina segments, within a lamination stack as specified by the control apparatus, wherein the number of A metal laminae and the number of B metal laminae are determined by the control apparatus on the basis of a holding force to be maintained within a specified holding force range between the stack segments. The number of A metal laminae and, if necessary, also of B metal laminae is readjusted or corrected if the holding force between the stack segments is not (or no longer) within the specified holding force range.

By means of the thus-configured tool system and the thus-performed method for producing the structural unit, a production process for the structural unit that can be easily adapted to different requirements and reliably controlled is achieved.

An advantageous embodiment for the structural unit is that the A lamina segments in the circumferential direction are each provided on their one side with at least one undercut groove-like holding recess and on their other side in the circumferential direction with a complementary holding extension adapted thereto and insertable with a coordinated holding force, and that the B lamina segments in the circumferential direction are each provided on their one side in the circumferential direction with at least one undercut groove-like mold recess and on their other side in the circumferential direction with a mold extension adapted thereto and insertable (practically) without holding force.

Further advantages of the structural unit result from the fact that the lamina segment groups A have at least two A lamina segments and the lamina segment groups B have at least two B lamina segments and that each stack segment comprises at least two lamina segment groups A and at least two lamina segment groups B, wherein the lamina segment groups A and lamina segment groups B alternate (in the same way) within the stack segments. An advantageous embodiment is in particular that only two different lamina segments, namely A lamina segments and B lamina segments, are present within the stack segment.

For example, one embodiment variant is that, within a stack segment, at least two lamina segment groups A relative to one another and/or at least two lamina segment groups B relative to one another and/or at least one lamina segment group A relative to at least one lamina segment group B have a different number of A lamina segments or B lamina segments.

An advantageous embodiment of the method is that the holding force between the stack segments is measured. By measuring the holding force, it is advantageously possible to check whether, during the production process, e.g., after a separating process for applying a winding and for reassembly, the holding force is or remains within the holding force range to be maintained, and the number of the A lamina segments exerting a holding force can be adjusted accordingly, in particular automatically by means of a control process via the control apparatus. For example, in limit cases, in order to maintain the specified holding force range, it is also possible to layer only A metal laminae to form the lamination stack.

For an automatic process sequence, it is advantageously provided that, when the specified holding force range is fallen below, the number of A metal laminae is increased and, when the holding force range is exceeded, the number of A metal laminae is reduced to such an extent that the holding force is within the specified holding force range, wherein the increased number of A metal laminae is compensated for by omitting B metal laminae and the reduced number of A metal laminae is compensated for by adding B metal laminae, if necessary, in order to maintain a specified stack height of the lamination stack.

Various advantageous design options for automatic process control, in particular for controlling the process sequence, are that, during the production process, the holding force is measured for each lamination stack after completion of the lamination stack or randomly for a lamination stack after completion of multiple lamination stacks and that the measurement results are fed to the control apparatus manually or (preferably) automatically.

Advantageous method variants are that the measurement of the holding force is carried out in the radial direction (at right angles to the longitudinal axis) of the lamination stack and comprises a measurement of the separation force and/or a measurement of the joining force.

For the formation of the structural unit and precise process control, it is furthermore advantageous that the holding force is measured after compression of the metal laminae of the lamination stack and that a measurement of the stack height and stack parallelism of the lamination stack is carried out before or after the measurement of the holding force or in case the holding force is not measured.

The tool system is advantageously designed for automatic process control such that a measuring apparatus for measuring the holding force between the stack segments is integrated in the tool system, that the measured holding force is fed or can be fed to the control apparatus by means of a transmission device and that the control apparatus is designed such, that if the measured holding force deviates from the specified holding force range, the number of A metal laminae in the lamination stack is increased or reduced so that the holding force is within the specified holding force range, whereas the number of B metal laminae in the lamination stack is reduced or increased accordingly in order to maintain a specified stack height. The measured holding force within the process control can thus be easily used to control the process sequence while maintaining the holding force within the specified holding force range. With the tool system designed in this manner, different requirements, e.g., for different electric machines, can also be fulfilled in a simple manner and practically without much effort.

Another advantageous embodiment of the tool system is that the tool arrangement has a compaction unit for compressing the metal laminae stacked on top of one another to form the lamination stack, which compaction unit is positioned upstream of any measuring apparatus for measuring the holding force in the process sequence.

Furthermore, the tool system is advantageously designed in that the tool arrangement has a measurement arrangement, in particular assigned to the compaction unit, for measuring the stack height and/or the parallelism of the end faces of the lamination stack.

A further advantageous embodiment of the tool system is that the measuring apparatus for measuring the holding force has a pull-off device and/or a joining device for measuring a separation force and/or joining force.

The object of the invention furthermore comprises a stator of a rotating electric machine with a structural unit, wherein a stator tooth is formed on each stack segment and winding spaces with insertable or inserted windings are arranged between the stator teeth of adjacent stack segments.

The invention is explained in more detail below with reference to the drawings by means of exemplary embodiments. In the figures:

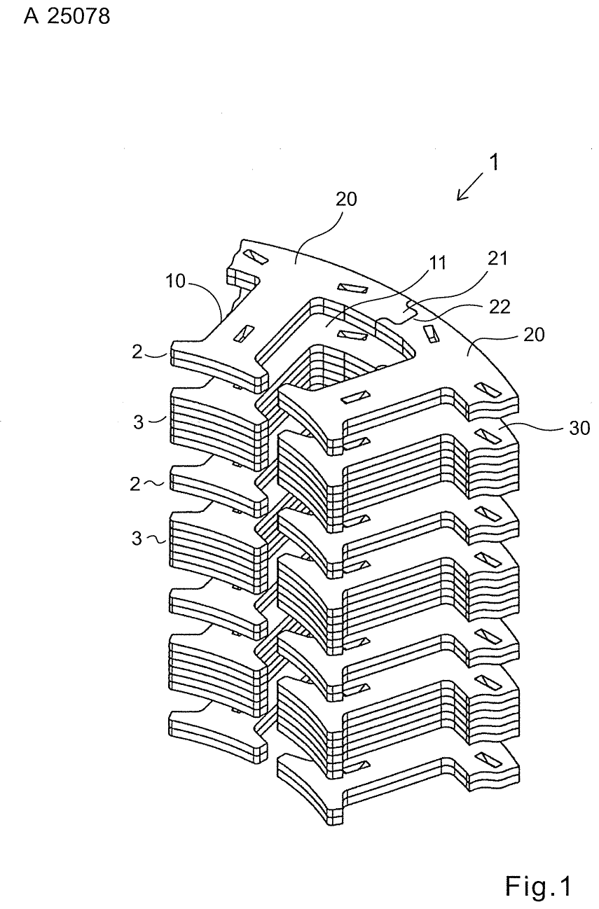

FIG. 1 shows a section of a lamination stack with two stack segments, which are assembled in the circumferential direction and are each formed in the same way from two different lamina segment groups A and B stacked on top of one another in the direction of the longitudinal axis of the lamination stack, with A lamina segments and B lamina segments which are identical within the group but different from group to group, in a perspective representation pulled apart in the longitudinal direction between the groups,

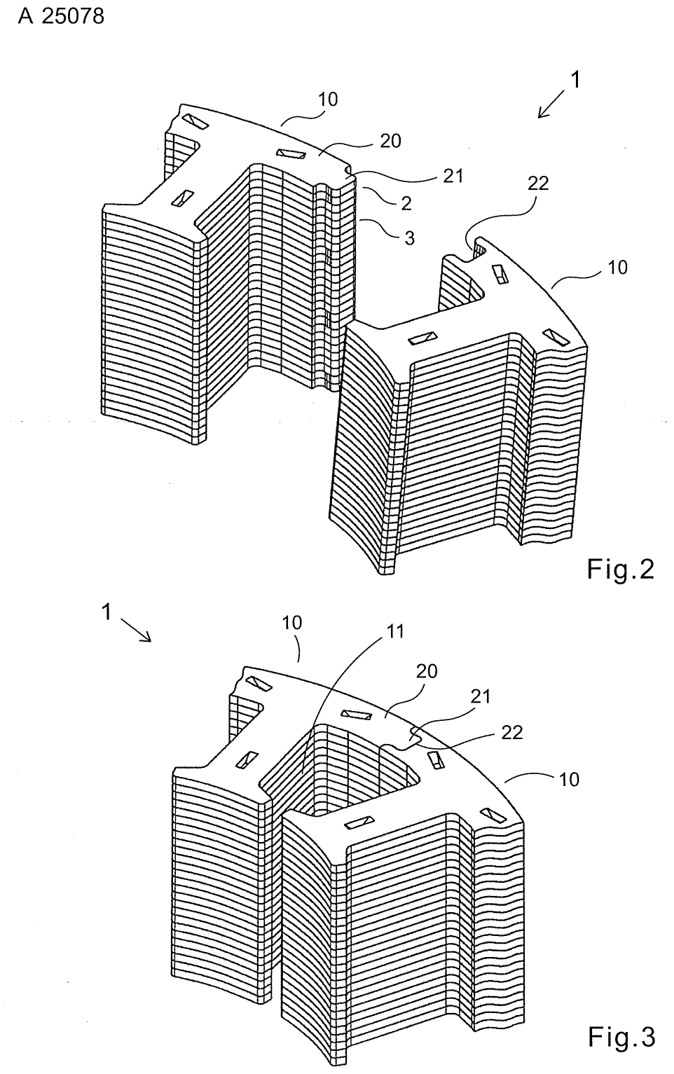

FIG. 2 is a perspective representation of two stack segments pulled apart in the circumferential direction, with lamina segment groups A and B lying on top of one another in the longitudinal direction,

FIG. 3 is a perspective representation of the stack segments according to FIG. 2 in their state assembled in the circumferential direction,

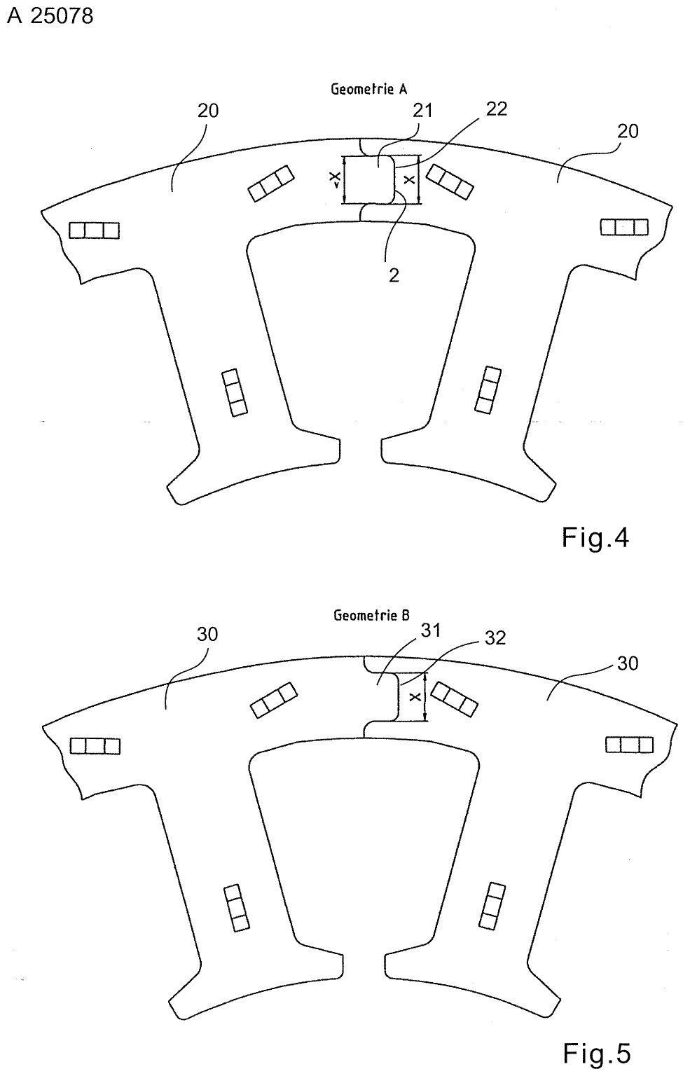

FIG. 4 is a top view of two A lamina segments assembled in the circumferential direction, with holding structures of a geometry A with holding extension and holding recess marked in more detail,

FIG. 5 is a top view of two B lamina segments assembled in the circumferential direction, with more detailed identification of their holding structures of a geometry B with mold extension and mold recess,

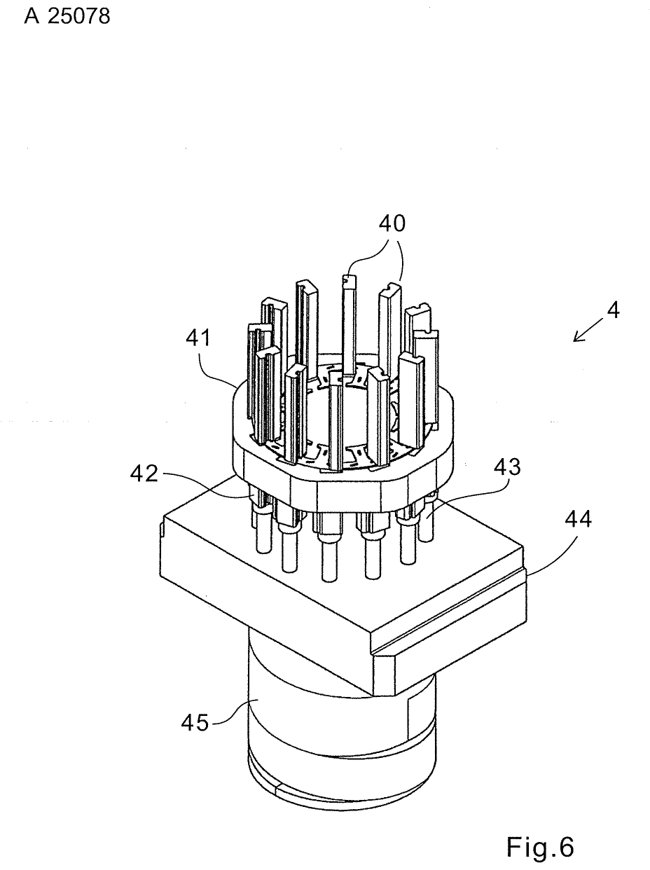

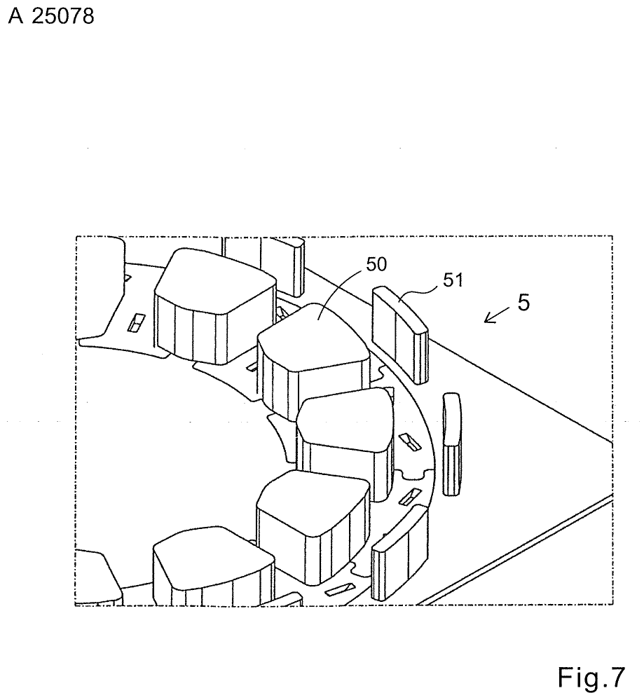

FIG. 6 is a perspective view of a cutting unit for metal laminae with cutting elements for forming holding structures of the lamina segments,

FIG. 7 is a sectional perspective view of a further cutting unit for cutting further cutting contours of the metal laminae,

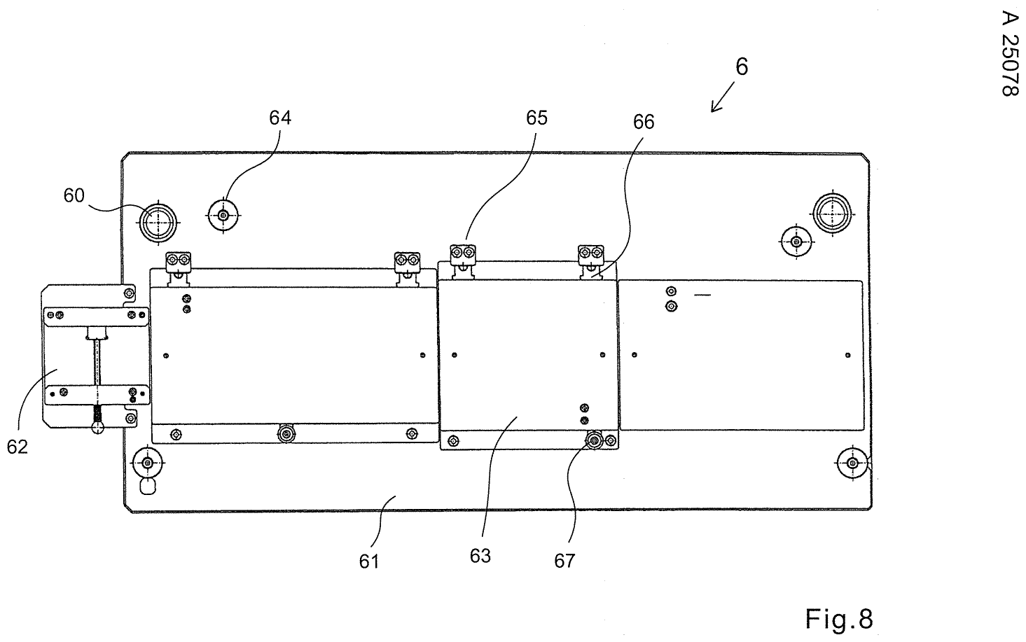

FIG. 8 is a top view of a punching tool structure with parts of a tool frame,

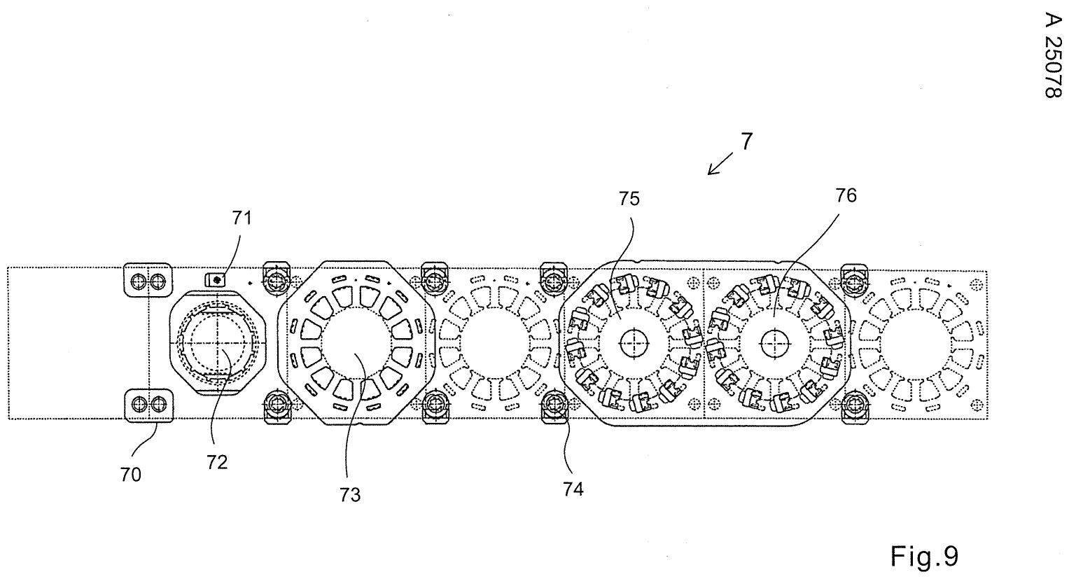

FIG. 9 is a schematic top view of a tool arrangement of a tool system for producing a lamination stack,

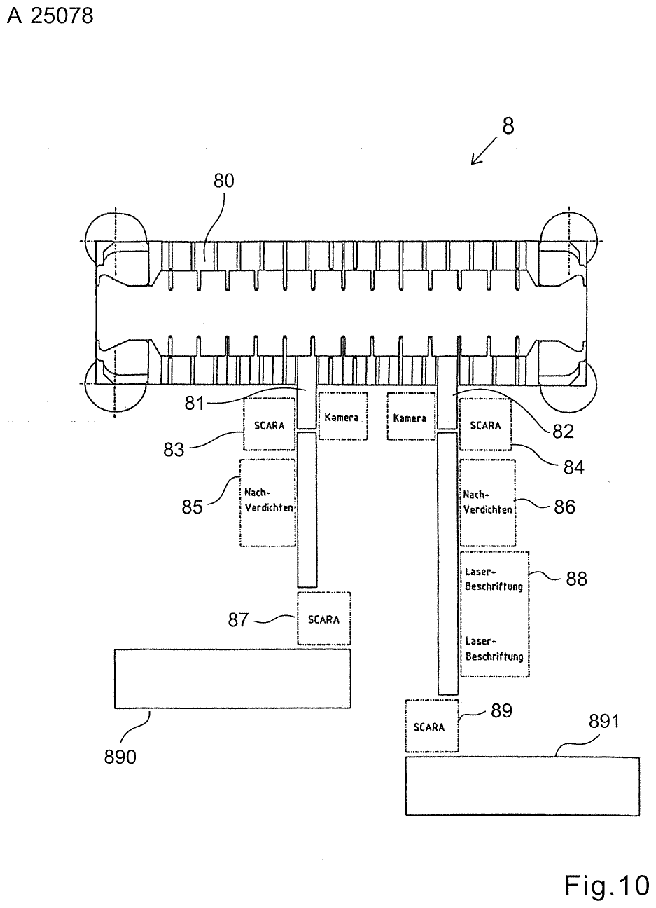

FIG. 10 is a schematic view of a production system for manufacturing lamination stacks, and

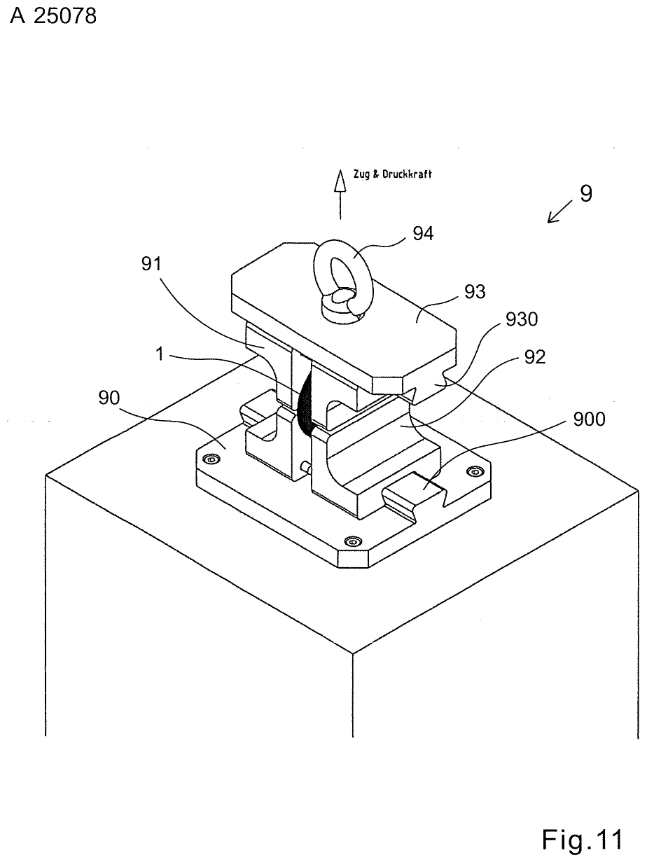

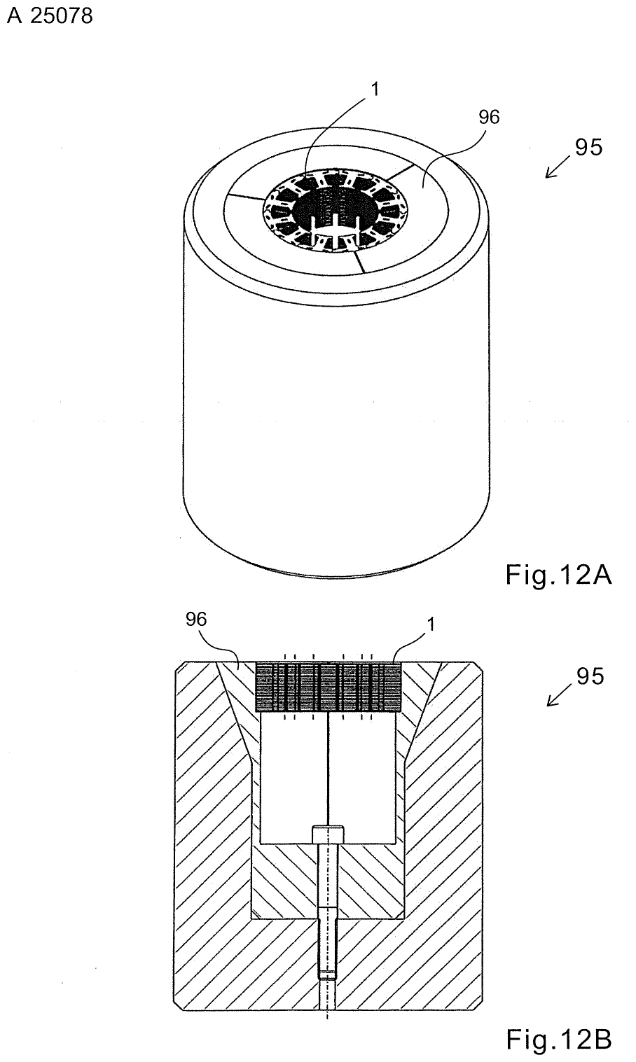

FIG. 11 shows a measuring apparatus for measuring the holding force between the stack segments of a lamination stack, and

FIGS. 12A and 12B show a measuring device for measuring the roundness of a lamination stack, in particular a stator.

FIG. 1 to 3 show a section of a lamination stack 1 with two stack segments 10 to illustrate the structural principle of a lamination stack in various representations in perspective view. The lamination stack 1 forms, for example, the laminated metal stack of a stator of a rotating electric machine, such as an electric motor. The stack segments are assigned to individual stator teeth and in the present case each have a radially inward directed stator tooth with tooth tip and winding spaces 11 between the stator teeth for accommodating a stator winding (not shown). In the area radially outward from the tooth tip, in this case the stator yoke, the stack segments 10 are assembled by holding structures and can be separated from one another with a certain pull-off force directed radially in a plane perpendicular to the longitudinal axis of the lamination stack 1, so that the winding can then be applied to the stator teeth as easily as possible. The stack segments 10 are then assembled again to form the lamination stack 1 or stator with a radially inward directed joining force, wherein the holding structures are designed to exert a sufficient holding force to ensure reliable functioning of the electric machine.

As illustrated in FIG. 1, the stack segments 10 of the lamination stack 1 are constructed from two lamina segment groups stacked on top of one another in the direction of the longitudinal axis of the lamination stack 1, namely a lamina segment group A 2, which are provided with holding structures, which exert a certain holding force in the radial direction of the lamination stack 1, and a lamina segment group B 3, which exerts practically no force or a significantly lower force (e.g., at most half or at most 60% or 80% of the holding force) in comparison to the lamina group A 2. The lamina segment groups A 2 and B 3 are alternately stacked on top of one another.

Depending on the holding force to be generated, each lamina segment group comprises multiple identical lamina segments, namely, the lamina segment group A 2 comprises A lamina segments 20 which exert a holding force with their holding structures, and the lamina segment group B 3 comprises B lamina segments 30 which exert no holding force with their holding structures or at most a substantially lower holding force (e.g., at most half or at most 60% or 80% of the holding force of the A lamina segments).

In the exemplary embodiment shown in FIG. 1, an A lamina segment group A 2 with two A lamina segments 20 is initially arranged facing the upper end face, a lamina segment group B 3 with six B lamina segments 30 is arranged below it, followed alternately by a lamina segment group A 2 with two A lamina segments 20 and a lamina segment group B 3 with six B lamina segments 30, as well as a further lamina segment group A 2 with two A lamina segments 20 and a lamina segment group B 3 with six B lamina segments 30, and finally, toward the lower end face, a lamina segment group A 2 with two A lamina segments 20. Here, the number of lamina segment groups A 2 and the number of A lamina segments 20 arranged within the lamina segment group A 2 is selected such that the holding force between the stack segments 10 is within a specified holding force range.

The holding force can be predetermined by the design of the holding structures on the A lamina segments 20 (and possibly of the B lamina segments 30) by measurement and/or simulation but is advantageously (possibly additionally) measured within the production process by means of a measuring apparatus, as explained in further detail below. Depending on the holding force to be applied, the number of A lamina segments 20 within the lamina segment group A 2 of the respective stack segments 10 and the number of lamina segment groups A 2 within the stack segments 10 can thus be varied in order to maintain the holding force between the stack segments 10 within the specified holding force range. From lamina segment group A 2 to lamina segment group A 2 within a stack segment 10, the number of A lamina segments 20 may remain the same or vary.

The structure of the stack segments 10 forming the lamination stack 1 and having the lamina segment groups A 2 and B 3 stacked in the direction of the longitudinal axis of the lamination stack 1 is the same from stack segment 10 to stack segment 10, i.e., the stack segments 10 are identically constructed in the same way from lamina segment groups A 2 and B 3 with respective A lamina segments 20 and B lamina segments 30. By arranging more or fewer lamina segment groups B 3 and/or more or fewer B lamina segments 30, the stack height of the lamination stack 1 can be varied (without or without substantially changing the holding force) so that a specified dimension of the lamination stack 1 or a stator built from it can be precisely maintained.

In the structure of the lamination stack 1, it can be advantageous if the lamination stack 1 is terminated on its two end faces with lamina segment groups A 2. It can also be advantageous to arrange at least one lamina segment group A 2 in the central area to exert a holding force.

In FIG. 2, the two stack segments 10 shown in FIG. 1 are shown in an arrangement pulled apart in the circumferential direction and with the lamina segment groups A 2 and B 3 stacked compactly on top of one another in the longitudinal direction. In FIG. 3, the two stack segments 10 shown in FIG. 2 are shown in an arrangement assembled in the circumferential direction. The holding forces exerted between the stack segments 10 act both as pull-out forces (separation forces) when the stack segments 10 are pulled apart and as joining forces when the stack segments 10 are assembled to form the lamination stack 1.

FIGS. 4 and 5 show exemplary holding structures of a geometry A of two assembled A lamina segments 20 (FIG. 4) and a geometry B of two assembled B lamina segments 30 (FIG. 5).

As FIG. 4 shows, the holding structures of geometry A of the A lamina segments 20 has a holding extension 21 on one side in the circumferential direction and a holding recess 22, complementary to the holding extension 21, on its side opposite in the circumferential direction so that two A lamina segments 20 can be joined with their holding projection 21 and their holding recess 22 in a fixing manner. The holding recess 22 is designed as an undercut U-shaped groove, the groove opening of which, lying approximately in a radial plane perpendicular to the lamina plane, is narrower in or near the entrance area than its clear width toward the groove base, while the complementary holding extension 21 has a correspondingly larger dimension toward its free end than its extent lying in the attachment area of the A lamina segment 20. This means that the entrance area of the holding recess 22 or the attachment area of the holding extension 21 has a smaller extent X than the adjoining undercut groove area of the holding recess 22 or the area of the holding extension 21 lying toward the free end, so that a clamping effect exerting the holding force results when the holding extension 21 and holding recess 22 are assembled. This means that the holding force can be precisely predetermined depending on the geometry and material, e.g., by simulation and/or (primarily) by measurement. Similar geometries resulting in a holding force are also possible (e.g., circular section shape).

The B lamina segments 30, on the other hand, are designed such that, when the mutually complementary holding elements of the holding structure are inserted, there is no holding force or at most a very low or in any case significantly lower (e.g., at most half as high) holding force than for the two A lamina segments 20. This is achieved in that, in the case of the B lamina segments 30, a groove-shaped mold recess 32 pointing in the circumferential direction, e.g., also in a U-shape, has no undercut, i.e., no narrowed opening area, and a complementary mold extension 31 is not widened toward its free end in comparison to its attachment area on the B lamina segment 30 but has, for example, mutually parallel or tapered flanks corresponding to the groove flanks of the mold recess 32. For example, the flanks of the mold recess 32 and of the mold extension 31 can run in parallel with one another in a width X, as shown in FIG. 5. In order to pull apart and assemble as smoothly as possible and for production reasons of the stack segments 10, the holding extensions 21 and holding recesses 22 according to FIG. 4 and the mold extensions 31 and mold recesses 32 according to FIG. 5 are advantageously rounded in their opening area and in the transition area toward the groove base. Furthermore, it is advantageously provided that the holding extensions 21 and mold extensions 31 as well as the holding recesses 22 and mold recesses 32 are similarly shaped so that assembly of the stack segments is not made more difficult in the event of (slight) axial displacement of the metal laminae, as can occur as a result of a winding process.

For producing the lamination stacks 1, the individual metal laminae are produced in an advantageous full-cut procedure, in which the required cutting contours for the air gap and the clearances for the winding or the tooth contour and any further contours to be cut and also the separating lines between the individual lamina segments of the metal laminae are completely cut in an appropriately designed cutting unit, in particular in an automatic punching press. In order to produce metal laminae that correspond to the A lamina segments 20 on the one hand and to the B lamina segments 30 on the other hand, two cutting units 4 provided with corresponding cutting geometries A and B are used in the present case in the relevant tool arrangement 7 or production system 8 (cf. FIGS. 9 and 10). A cutting unit 4 is shown as an example in FIG. 6. The cutting unit 4 comprises cutting punches 40 for producing the holding structures and adjacent contour portions, as well as a cutting insert 41, ejectors 42, transfer pins 43, a transfer plate 44, and a pressure spring 45.

Due to the complete cutting of the metal laminae by means of the two correspondingly designed cutting units 4, the metal laminae with the A lamina segments 20 assembled in a ring shape as well as the metal laminae with the B lamina segments 30 assembled in a ring shape result in a high precision of the metal laminae and the lamination stack 1 consisting of them. With a stator constructed in this manner, an extremely small gap, which can be precisely maintained, is created during joining after the winding has been applied. This is important since external influences can cause an axial offset of the laminae in relation to one another (e.g., due to the winding tension). For example, in the case of only partially cut pre-cuts (as is also common in conventional prior-art methods), i.e., pre-cuts that are not completely cut through, an undefined, partially protruding residual fracture structure remains, which can no longer be assembled without a gap, as a result of which the important roundness is no longer given or is significantly impaired.

The holding extensions 21 or mold extensions 31 as flared wings are pressed directly back into their initial position and flattened with the help of the ejector 42 in the relevant cutting unit 4 after the cutting process. The ejector 42 is actuated by the spring force of the pressure spring 45 (helical pressure spring), the transfer plate 44, and the transfer pin 43 and produces a flat metal lamina or (in the case of a stator) stator lamina. Both processing steps, i.e., both cutting and pressing back, take place in the same station, namely the relevant cutting unit 4, which economically advantageously saves an additional planing station for both cutting units 4 (both for geometry A and for geometry B).

What is essential for the structure of the lamination stack 1 formed from the A lamina segments 20 and the B lamina segments 30 is that the ratio of the number of A lamina segments 20 to the number of B lamina segments 30 can be freely adjusted depending on the required holding force, in particular the radial pull-off force. A relevant control or regulation of the arrangement of the A lamina segments 20 and B lamina segments 30 during the structure of the lamination stack 1 can be specified by the relevant design of a control apparatus of the production system.

In principle, a cutting device in which not the complete metal laminae but only the A lamina segments 20 are cut in a cutting station and the B lamina segments 30 in a further cutting station and the A lamina segments 20 and B lamina segments 30 stacked in the same way are assembled as initially separate stack segments 10, e.g., after the winding has been applied, would also be possible but is considered less advantageous in the present case due to disadvantages in terms of precision.

In particular, it is advantageous for use in the structure of a stator if the outer diameter of the lamination stack 1 remains the same throughout. Overall, this leads to a higher load-bearing capacity and better force distribution in a stator sleeve than with a non-continuous stator outer diameter. Cutouts for the aforementioned formation of the lamination stack are therefore advantageously not directly on the outer diameter of the lamination stack 1. In addition to the load-bearing capacity of a stator constructed in this way at the separation points, the continuous outer diameter is also advantageous for the application of a marking on the lateral surface. If the cutouts for the separation points of the lamina segments are not directly on the outer diameter, longer cutouts are possible in order to make it possible to bend out the holding extensions 21 or mold extensions 31 without damaging the material. The undercut is then only on the inside of the relevant lamina segment. This means that if the metal laminae are axially offset, there are no radial thrusts that have a negative effect on the outer diameter of the lamination stack 1 or the stator. FIG. 7 schematically shows a cutting punch 50 for the winding spaces 11 and a pre-cutting punch 51 for cutouts on the outer diameter. The cutouts are required for performing the shearing process.

The cutting units 4 and further cutting units 5 are advantageously designed as punching tools in a structure with individual modules. FIG. 8 schematically shows a punching tool structure 6 with a tool frame, which has frame columns 60 and a base plate 61. Sheet metal to be cut or punched is fed via a belt infeed 62 to a module 63 designed for processing. The individual cutting modules are mainly used for handling. To date, the modular construction has not been common practice for punch-stacking. The immersion depth of the entire punching tool can be secured using spacer elements 64. A clamp 65, sliding inserts 66, 67 provide a precise sliding mechanism for the modules.

The tool arrangement shown in FIG. 9 has a cutting apparatus with a catcher hole 70 and an index punch 71, as is known per se. An air gap cutting station 72 is used for high-precision cutting of an air gap. The winding spaces and a pre-cut are subsequently cut in a winding space and pre-cut cutting station 73. Catchers and lifters 74 are provided for further processing. Cutting stations 75 and 76 with the respective cutting units are present for cutting the A lamina segments 20 and the B lamina segments 30 and in the present case form the substantially main cutting processes of the invention.

FIG. 10 schematically shows a production system 8, in which the production concept according to the invention is implemented. The production system 8 is designed, for example, for constructing parts of an electric machine with rotor and stator and comprises an automatic punching press 80, a rotor conveyor belt 81, a stator conveyor belt 82, a first robot unit 83 on the rotor conveyor belt 81 and a second robot unit 84 on the stator conveyor belt 82, a measuring and post-compaction unit 85 on the rotor conveyor belt 81, a further measuring and post-compaction unit 86 on the stator conveyor belt 82, a third robot unit 87 in the rotor line, labeling units 88 for the lateral and end surfaces, a fourth robot unit 89 in the stator line, and conveyor units 890, 891 for blisters in the rotor and stator lines. The degree of automation of the process line can be adjusted depending on the quantity. Laser labeling is optional.

The rotor conveyor belt 19 transports the rotor away under the tool, the stator conveyor belt 20 transports the stator away under the tool. The robot units 21, 22 are preferably designed as SCARA robots, which place the parts from the respective conveyor belt onto the linear conveyor unit in an oriented manner. The measuring and post-compaction units 85 and 86 compress the relevant lamination stacks of the rotor or stator and measure their height and parallelism. The robot units 87, 89, also designed as SCARA robots, place the compacted lamination stacks of the rotor or stator into the blisters or KLT containers provided, which are positioned via the relevant conveyor units 890, 891.

In the automatic punching press 80, which is designed in particular as a high-performance automatic punching press, the individual metal laminae are punched completely through. The holding forces between the stack segments 10 of the lamination stack 1 are measured in an assigned measuring station at defined intervals during production, wherein the feed to the same can take place automatically. The measurement results are fed directly into a control apparatus of the production system 8. In this manner, the radial holding forces or pull-off and/or joining forces are controlled or can be automatically controlled during production. A stacking device with an integrated rotating unit within the tool arrangement 7 stacks the ring-shaped metal laminae in a controlled or regulated arrangement to form the lamination stack 1. The lamination stacks 1 or the stators formed from them are transferred to the compaction unit 86 or (in the case of a rotor) 85 by means of the conveyor system. The height of the lamination stack can be measured by means of the relevant measuring unit, allowing the number of laminae to be regulated during the production process. In this manner, individual metal laminae can be added or removed as required. In addition, the parallelism of the lamination stack 1 can be measured in order to ensure precise function.

The integrated control of the number of A lamina segments 20 makes precise adjustment of the radial holding force possible, wherein the measured holding force is compared with a specified holding force and the number of A lamina segments 20 is automatically selected such that the holding force is within the specified holding force range. In particular, the pull-out force (separation force) between the stack segments 10 is used to measure the holding force. The holding force between the stack segments 10 of the lamination stack 1 can thus be adjusted within a fixed range independently of tool wear, the material strength, and/or the height of the lamination stack 1. This contributes substantially to a consistently high quality of the lamination stack 1 and thus also of the stator or electric machine constructed from it.

FIG. 11 shows the structure of a measuring apparatus 9 for measuring the holding forces between the stack segments 10 of a lamination stack 1. The holding forces, in particular separation forces between two diametrically opposed pairs of stack segments 10 are measured simultaneously and half the value of this separation force is taken as the holding force between two stack segments 10. This measurement result is fed to the control apparatus for regulating the number of A lamina segments 20. The number of B lamina segments is adjusted accordingly in order to maintain a specified stack height of the lamination stack 1.

After measuring the separation force or holding force by means of the measuring apparatus 9, the two halves of the lamination stack 1 are pressed together again and the entire lamination stack 1 is rotated by one pitch of the stack segments 10. The test is then repeated until all separating lines have been tested. The determination of the measured holding force can be based on a statistical determination (e.g., averaging, exclusion in the event of excessive deviations from an average value or similar). Furthermore, the joining forces for assembling the stack segments 10 can also be measured by means of the measuring apparatus 9 when the relevant halves of the lamination stack 1 are pressed together. The integrated measurement of both the radial pull-off and/or joining forces and the stack height and parallelism of the lamination stack 1 makes it possible to precisely maintain the required holding forces, namely the pull-off and/or joining forces.

FIG. 11 shows a schematic representation of the structure of the measuring apparatus 9 with a separating device. A first guide unit 90 has a guide rail 900 (e.g., in the form of a dovetail guide), and a second guide unit 93 has a further guide rail 930 (e.g., also a dovetail guide). A lower pair of clamping jaws 92 and an upper pair of clamping jaws 91 are guided on the guide rails 900 and 930. The second guide unit 93, at the top in FIG. 11, is suspended in a floating manner via a suspension means 94. One half each of the lamination stack 1 with the respective stack segments 10 is clamped between the upper pair of clamping jaws 91 and the lower pair of clamping jaws 92 so that the two halves of the lamination stack 1 can be measured by exerting a tensile force on the upper pair of clamping jaws 91 via the second guide unit 93 with the suspension means 94 while measuring the pull-off force (separation force) between the two halves of the lamination stack 1 or the separation points between the respective stack segments 10 by means of the measuring apparatus 9. Accordingly, the joining force for assembling the two halves of the lamination stack 1 or the relevant stack segments 10 can also be measured in the opposite direction to the pull-out direction.

Furthermore, the measurement of the outer diameter and of the roundness of the lamination stack 1, as shown in FIGS. 12A and 12B, can be made possible, for example, via a conical clamping ring 96 located in an inner form of a separate measuring device 95 and having outer conical segments for centric and round clamping of a lamination stack 1 or stator. For opening the segments, for example, there is an eyelet shape in the ring or on the segments.

The presented structure according to the invention of the structural unit for an electric machine with the lamination stack formed in this way, the presented method for producing the structural unit, and the production system with the tool system for producing the structural unit contribute substantially to increasing the precision of the structural unit and electric machines equipped with it and at the same time make flexible adaptation of the production process possible.

1. A structural unit for an electric machine, such as a rotor or in particular a stator, having a lamination stack (1) which is composed of a plurality of metal laminae layered on top of one another in the direction of a longitudinal axis and which is assembled in the circumferential direction from multiple stack segments (10) having lamina segments which are arranged in the circumferential direction and which interlock by means of lateral holding structures,
characterized in that
the stack segments (10) forming the lamination stack (1) are constructed in layers in the same manner from at least two different lamina segment groups A (2) of identically contoured A lamina segments (20) and lamina segment groups B (3) of identically contoured B lamina segments (30), wherein the A lamina segments (20) differ from the B lamina segments (30) in their holding structures in terms of their holding force in at least the radial direction in the plane of the metal laminae.

2. The structural unit according to claim 1,
characterized in that
the A lamina segments (20) are each provided in the circumferential direction on their one side with at least one undercut groove-like holding recess (22) and on their other side with at least one complementary holding extension (21) which is adapted thereto and can be inserted with a coordinated holding force, and
the B lamina segments (30) are each provided in the circumferential direction on their one side with at least one groove-like mold recess (32) and on their other side with a mold extension (31) which is adapted thereto and can be inserted without holding force.

3. The structural unit according to claim 1 or 2,
characterized in that
the lamina segment groups A (2) have at least two A lamina segments (20) and the lamina segment groups B (3) have at least two B lamina segments (30), and
each stack segment (10) comprises at least two lamina segment groups A (2) and at least two lamina segment groups B (3), wherein the lamina segment groups A (2) and lamina segment groups B (3) alternate in the same manner within the stack segments (10).

4. The structural unit according to one of the preceding claims,
characterized in that
within a stack segment (10), at least two lamina segment groups A (2) relative to one another and/or at least two lamina segment groups B (3) relative to one another and/or at least one lamina segment group A (2) relative to at least one lamina segment group B (3) have a different number of A lamina segments (20) or B lamina segments (30).

5. A method of producing a structural unit according to one of claims 1 to 4, in which
a metal band is fed to a tool arrangement (7),
A metal laminae with circumferentially joined A lamina segments (20) and B lamina segments with circumferentially joined B lamina segments (30) are cut out of the metal band, wherein lateral holding structures of the A lamina segments (20) differ from lateral holding structures of the B lamina segments (30) in their holding force, and
A metal laminae and B metal laminae are automatically layered on top of one another in a sequence specified by a control apparatus, in the direction of a longitudinal axis to form a lamination stack (1) or B metal laminae are completely omitted so that the holding force between the stack segments (10) layered from the A lamina segments (20) and B lamina segments (30) or without B lamina segments (30) is within a specified holding force range.

6. The method according to claim 5,
characterized in that
the holding force between the stack segments (10) is measured.

7. The method according to claim 5 or 6,
characterized in that
when the specified holding force range is fallen below, the number of A metal laminae is increased and, when the holding force range is exceeded, the number of A metal laminae is reduced to such an extent that the holding force is within the specified holding force range, wherein the increased number of A metal laminae is compensated for by omitting B metal laminae and the reduced number of A metal laminae is compensated for by adding B metal laminae in order to maintain a specified stack height of the lamination stack (1).

8. The method according to claim 6 or 7,
characterized in that
the holding force is measured during the production process for each lamination stack (1) after completion of the lamination stack (1) or randomly for a lamination stack (1) after completion of multiple lamination stacks (1), and
the measurement results are fed to the control apparatus manually or automatically.

9. The method according to one of claims 6 to 8,
characterized in that
the measurement of the holding force is carried out in the radial direction of the lamination stack (1) and comprises a measurement of the separation force and/or a measurement of the joining force.

10. The method according to claim 8 or 9,
characterized in that
the holding force is measured after compression of the metal laminae of the lamination stacks (1), and
a measurement of the stack height and stack parallelism of the lamination stack (1) is carried out before or after the measurement of the holding force or in case the holding force is not measured.

11. A tool system for producing a structural unit for an electric machine, such as a stator or rotor, in particular according to claim 1, in which a punching arrangement for cutting metal laminae to be layered on top of one another to form a lamination stack (1) is present in a tool arrangement (7) of a production system (8), wherein the punching arrangement has multiple cutting stations (72, 73, 75, 76) with cutting units (4, 5) for cutting the metal laminae into lamina segments, which are assembled circumferentially with lateral holding structures so that they can be disassembled and reassembled after disassembly, and required further cutting portions of the metal laminae, and furthermore a stacking device controlled by a control apparatus is present for forming the lamination stack (1) from stacked metal laminae, the lamination pack being composed of stack segments (10) in the circumferential direction,
characterized in that
two different cutting stations (75, 76) are present for cutting the lamina segments, one of which (e.g., 75) is designed for cutting A lamina segments (20), the lateral interlocking holding structures of which are designed to exert radial holding forces, and the other cutting station (e.g., 76) is designed for cutting B lamina segments (30), the lateral interlocking holding structures of which are designed to exert lower holding forces than the holding structures of the A lamina segments down to practically no holding forces, and
the stacking device is designed for arranging a number of A metal laminae, composed of A lamina segments (20), and a number of B metal laminae, composed of B lamina segments (30), within a lamination stack (1) as specified by the control apparatus, wherein the number of A metal laminae and the number of B metal laminae are determined by the control apparatus on the basis of a holding force to be maintained within a specified holding force range between the stack segments (10).

12. The tool system according to claim 11,
characterized in that
a measuring apparatus (9) for measuring the holding force between the stack segments is integrated in the tool system,
the measured holding force is fed to the control apparatus by means of a transmission device, and
the control apparatus is designed such that, if the measured holding force deviates from the specified holding force range, the number of A metal laminae in the lamination stack (10) is increased or reduced such that the holding force is within the specified holding force range, whereas the number of B metal laminae in the lamination stack (10), conversely, is reduced or increased accordingly.

13. The tool system according to claim 11 or 12,
characterized in that
the tool arrangement (7) has a compaction unit (85) for compressing the metal lamina stacked on top of one another to form the lamination stack (10), which compaction unit is positioned upstream of any measuring apparatus for measuring the holding force in the process sequence.

14. The tool system according to one of claims 11 to 13,
characterized in that
the tool arrangement (7) has a measurement arrangement, in particular assigned to the compaction unit (85), for measuring the stack height and/or the parallelism of the end faces of the lamination stack (10).

15. The tool system according to one of claims 12 to 14,
characterized in that
the measuring apparatus (9) for measuring the holding force has a pull-off device and/or a joining device for measuring a separation force and/or joining force.

16. A stator of a rotating electric machine having a structural unit according to claim 1, wherein a stator tooth is formed on each stack segment (10) and winding spaces with insertable or inserted windings are arranged between the stator teeth of adjacent stack segments (10).
